(19) United States
(12) Patent Application Publication
(10) Pub. No.: US 2009/0179644 A1
(43) Pub. Date: Jul. 16, 2009

(54) Conveyor System

(76) Inventors: Vincent Alexander Bons, Leerdam (NL); Alexander Clemens Henricus Josef Schaepman, Breda (NL); Josefhus Francisca Eduardus Maria Krieckaart, Best (NL); Jozef Antonius Willem Maria Corver, Nuenen (NL)

Correspondence Address: Inttlectual Property;The BOC Group, 575 Mountain Avenue, Murray Hill, NY, 07974, US

(21) Appl. No.: 11/918,555

(22) PCT Filed: Apr. 21, 2006
(86) PCT No.: PCT/GB2006/001471

§ 371 Date: Feb. 23, 2009

(30) Foreign Application Priority Data
Apr. 28, 2005 (GB) 0508547.7

(51) Int. Cl. G01V 3/00

(52) U.S. Cl. 324/315

(57) ABSTRACT

A method of determining the mass of a moving sample is described, in which the sample is moved at a controlled velocity through a mass interrogation zone and a temperature interrogation zone, which may be upstream or downstream from the mass interrogation zone.

### FIELD OF THE DISCLOSURE

The present disclosure relates to a conveyor system, and in particular to a method of, and apparatus for, determining the mass of a sample conveyed on a conveyor system.

### BACKGROUND OF THE DISCLOSURE

In-line filling machines for dispensing products, such as liquid and/or powder drug samples, into containers or vials typically include a conveyor system for conveying the containers between functions. A filling station receives empty vials from the conveyor system, sequentially fills the vials with an accurate amount of one or more products and closes the thus-filled vials with closure members, for example, stoppers. The conveyor system then conveys the closed vials to an inspection station which checks that the vials have been correctly filled. A reject station is provided downstream from the inspection station for removing incorrectly filled vials from the production line. A sealing station may also be provided downstream from the reject station for sealing the vials.

International Patent Application WO 2004/104989, the contents of which are incorporated herein by reference, describes an inspection station that checks the mass of vials on a production line using NMR techniques. The inspection station includes a magnet for creating a static magnetic field over an interrogation zone to produce a net pre-magnetisation within a vial located in the interrogation zone, and an RF coil for applying an alternating magnetic field over the interrogation zone to cause pulse excitation of the sample contained within the vial. After the excitation, the sample relaxes and emits electromagnetic energy at the Larmor frequency of the molecules of the sample, the magnetic component of which induces a signal, known as the free induction decay (FID), in the form of current in the RF coil.

The amplitude of the induced current is proportional to the number of molecules in the sample, and the pre-magnetisation of the sample. The pre-magnetisation M_{z} of the sample can be expressed by the equation:

$${M}_{z} ∝ ( 1 - {e}^{( \frac{- t}{T 1} )} ) \cdot {B}_{o}$$

where Bₒ is the magnitude of the applied magnetic field, t is the duration of the application of the magnetic field to the sample, and T1 is the spin lattice relaxation time.

Currently, inspection stations such as that described in WO 99/67606 utilize a constant value of T1 for all inspected samples, and therefore the amplitude of the induced current is considered to be directly proportional to the number of molecules in the sample. The amplitude of the induced current is then compared to that produced by a calibration sample with known mass to determine the mass of the sample under analysis.

The value of T1, and thus the pre-magnetisation of the sample, varies with the temperature of the sample. A number of parameters influence the temperature of the sample at the inspection station. These parameters include:

The temperature of the sample and the vial during vial filling;

Temperature gradients within the sample; and

The rate of change of the temperature of the sample within the vial.

Where a plurality of filling stations are used side-by-side in a conveyor system, the temperatures of the filling stations may vary, for example, by as much as 0.5° C., depending on the relative positions of the filling stations. Variations in the homogeneity of the samples within the vials can lead to different temperature gradients within the samples. Variables such as the ambient temperature, differences in airflow across the samples, and different rates of heat transfer between the sample and the vial can lead to variations between samples in the rate of change of sample temperature.

The pre-magnetisation of the sample is usually considered complete after a pre-magnetisation period of approximately 5 times T1. For many pharmaceutical products, T1 is of the order of 1 second, and so to produce fully pre-magnetised pharmaceutical samples, a pre-magnetisation period of around 5 seconds would be required. However, pharmaceutical samples are often conveyed on fast moving conveyor systems, where vials are conveyed at a speed of up to 600 vials per minute, and so the NMR measurement is thus usually made on incompletely pre-magnetised samples. While this measurement is accurate enough if the temperature of the samples is uniform, small changes in T1 between samples, due to variation of the temperature of the samples, can lead to significant variations in the pre-magnetization of the samples, and thus lead to significant variations in the calculated masses of the samples.

Furthermore, conveyor systems often require to be stopped because, for example, the infeed of vials from an upstream station has been interrupted, the stopper supply system has to be replenished, an error situation has occurred or an operator has stopped the system. While the conveyor system is stationary, the samples located between the filling station and the inspection station cool, generally more rapidly for liquid samples than powder samples. Consequently, when the conveyor system is re-started, the temperatures of these samples when they reach the inspection station can be much lower than those of samples, both previously and subsequently, conveyed from the filling station to the inspection station without interruption. Due to the resulting error in the measurement of the mass of these samples, these samples are often discarded.

An embodiment of this disclosure solves these and other problems.

### SUMMARY OF THE DISCLOSURE

In an embodiment, the present disclosure provides a method of determining the mass of a moving sample, the method comprising the steps of:

causing the sample to move at a controlled velocity through a mass interrogation zone and a temperature interrogation zone;

using a magnetic resonance method, generating a first signal as the sample passes through the mass interrogation zone, the first signal having a characteristic which varies with the mass of the sample and with the temperature of the sample;

generating a beam of electromagnetic radiation of a terahertz frequency or a near-infrared wavelength and directing the beam through the temperature interrogation zone;

detecting the electromagnetic radiation reflected from or transmitted through the sample as it moves through the temperature interrogation zone;

from the detected electromagnetic radiation, generating a second signal having a characteristic which varies with the temperature of the sample; and

using the first and second signals, determining the mass of the sample.

Through distinctive absorption and/or reflection of terahertz or near-infrared radiation by the sample within the temperature interrogation zone, which may be located either immediately upstream from, or immediately downstream from, the mass interrogation zone, an accurate indication of the temperature of the sample can be provided. For example, solid pharmaceutical samples and liquids such as water have a characteristic absorption of NIR and terahertz radiation, and so by monitoring the radiation transmitted through the sample as it passes through the temperature interrogation zone, an indication of the temperature of the molecules within the sample, and thus of the temperature of the sample, can be provided. This temperature indication can then be used to compensate the characteristic of the first signal. Consequently, an accurate determination of the mass of the sample can be made.

The speed at which the temperature of a sample can be analyzed using terahertz or NIR radiation is comparable to the speed at which the mass of the sample can be determined using the NMR apparatus. As the speed at which samples are conveyed between the interrogation zones is known, the first and second signals produced from the samples as they pass through the interrogation zones can each be assigned to individual samples. Therefore, the method is suitable for use in determining the mass of each sample conveyed on a production line where the samples may be conveyed at a relatively fast speed, typically up to 600 vials per minute. Due to the speed at which the samples are conveyed through the NMR apparatus, incomplete pre-magnetization of the samples can significantly affect the characteristic of the first signal. However, with accurate temperature compensation provided by the present disclosure, the effect of the incomplete pre-magnetization of the samples on the calculated mass of the samples can be substantially eliminated. As accurate temperature compensation can be achieved irrespective of the temperature of the sample, in the event that the temperature difference between samples is relatively large, for example, due to interruption of the production line for any reason, this disclosure can provide for accurate measurement of the mass of the relatively cool samples, thereby significantly reducing the number of samples that require discarding in the event of an interruption.

The detected radiation may be compared with that reflected from or transmitted through a reference sample of known temperature. For example, time domain waveforms can be obtained from the detected radiation. These time domain waveforms may be transformed using a Fourier transformation algorithm into frequency domain waveforms, which may be compared with the equivalent reference waveforms generated from the reference sample. For example, a sequence of reference waveforms may be generated from either a moving or a static reference sample as it cools, and the waveform generated from the sample can be compared to these reference waveforms. From the result of the comparison, the temperature of the sample as it passes through the temperature interrogation zone can be determined, and subsequently used to produce a temperature compensated characteristic of the first signal. This characteristic can then be compared with a similar characteristic obtained from a similar sample of known mass to determine the mass of the sample. More specifically this comparison can be made using a statistical tool called ‘Principle Component Analysis’.

The container may be formed from any suitable material. In an embodiment, the materials are plastics and glass, such as quartz, materials that are substantially transparent to the beam of electromagnetic radiation.

In order to improve the accuracy with which the temperature of the sample is determined, in one embodiment the mass interrogation zone is located downstream from a first temperature interrogation zone and upstream from a second temperature interrogation zone, the sample being caused to move through the interrogation zones at the controlled velocity. A first beam of electromagnetic radiation of a terahertz frequency or a near-infrared wavelength is generated and directed through the first temperature interrogation zone, and a second, similar beam of electromagnetic radiation is generated and directed through the second temperature interrogation zone. The electromagnetic radiation reflected from or transmitted through the sample as it moves through the temperature interrogation zones is detected, from which second and third signals, each having a characteristic that varies with the temperature of the sample, are determined. The mass of the sample may then be determined using the first to third signals. For example, waveforms generated from the second and third signals may each be compared with the waveforms generated from the reference sample to determine the temperature of the sample as it passes through the first and second temperature interrogation zones respectively. Where the temperature interrogation zones are substantially equidistantly spaced from the mass interrogation zone, the average of the determined temperatures can provide an accurate estimation of the temperature of the sample within the mass interrogation zone, and so the characteristic of the first signal can be adjusted using this average to enable an accurate determination of the mass of the sample to be made. Alternatively, where the temperature interrogation zones are not equidistantly spaced from the mass interrogation zone, a weighted-temperature compensation may be performed using the second and third signals.

In an embodiment, the first signal is generated by applying a first magnetic field in a first direction in the mass interrogation zone for creating a net magnetization within the sample, applying an alternating magnetic field in a second direction in the mass interrogation zone for temporarily changing the net magnetization of the sample, and monitoring energy emitted from the sample as the net magnetization of the sample returns to its original state, whereby the characteristic of the first signal is proportional to the energy emitted.

As well as using the second (and third) signal(s) to perform temperature compensation of the first signal, other characteristics of the sample can be determined from these signals. Through distinctive absorption and/or reflection of terahertz and NIR radiation by different materials, physical and/or chemical characteristics such as, but not limited to:

“Fingerprinting” or characterisation of the sample;

Sample density;

Location and size of water concentrations;

Presence of metallic particles;

Sample temperature

Homogeneity of suspensions; and

Discontinuities in the sample packaging or container, can be determined. For example, information regarding density of a sample contained within a glass or plastics container can be obtained from reflected terahertz and NIR radiation. While glass and plastics are substantially transparent to terahertz and NIR radiation, due to the difference in refractive index between the material of the container and the material of the sample, the interfaces between the container and the sample will at least partially reflect terahertz radiation. By monitoring the time difference between the radiation reflected from the container/sample and the sample/container interfaces as the sample passes through the temperature interrogation zone, an indication of the density of the sample and the homogeneity of the sample density can be obtained. As another example, a change of shape and/or attenuation of the terahertz or NIR radiation as it passes through the temperature interrogation zone can be indicative of the material of the sample. Any imperfections in the surface of the container, in particular a plastics container, can be detected from the angle at which the beam is reflected from the interface.

Furthermore, as the radiation passes through the sample, different materials or structures within the sample will reflect the radiation in turn. These reflections will reach the detector at different times, and with different characteristics depending on the nature of the feature within the sample causing the reflection. By recording the reflections received from each point at which the beam is incident upon the sample as it moves through the temperature interrogation zone, information regarding the contents of the sample can be obtained.

Certain materials can be analysed through frequency-dependent absorption, dispersion, and reflection of terahertz radiation passing through a sample. By generating pulses of electromagnetic radiation having different frequency components, and monitoring changes in the amplitude and/or phase of the components of the radiation as the sample passes through the interrogation zone, it is possible to distinguish between different materials within the sample. For example, water molecules have a characteristic absorption of terahertz radiation, and so the inspection technique can be used to determine the location and the shape of volumes with a high concentration of water molecules within the sample.

In another embodiment, the present disclosure provides apparatus for determining the mass of a moving sample, the apparatus comprising:

conveying means for conveying the sample at a controlled velocity through a mass interrogation zone and a temperature interrogation zone;

magnetic resonance apparatus for generating a first signal as the sample passes through the mass interrogation zone, the first signal having a characteristic which varies with the mass of the sample and with the temperature of the sample;

first generating means for generating a beam of electromagnetic radiation of a terahertz frequency or a near-infrared wavelength and directing the beam through the temperature interrogation zone;

detecting means for detecting the electromagnetic radiation reflected from or transmitted through the sample as it moves through the temperature interrogation zone;

second generating means for generating from the detected electromagnetic radiation a second signal having a characteristic which varies with the temperature of the sample; and

determining means for using the first and second signals to determine the mass of the sample.

In another embodiment, the present disclosure provides a conveyor system comprising conveying means for conveying a sample at a controlled velocity through a mass interrogation zone and a temperature interrogation zone, magnetic resonance apparatus for generating a first signal as the sample passes through the mass interrogation zone, the first signal having a characteristic which varies with the mass of the sample and with the temperature of the sample, first generating means for generating a beam of electromagnetic radiation of a terahertz frequency or a near-infrared wavelength and directing the beam through the temperature interrogation zone, detecting means for detecting the electromagnetic radiation reflected from or transmitted through the sample as it moves through the temperature interrogation zone, second generating means for generating from the detected electromagnetic radiation a second signal having a characteristic which varies with the temperature of the sample, determining means for using the first and second signals to determine the mass of the sample, and rejecting means for rejecting the sample in dependence on the determined mass of the sample.

Features described above in relation to method aspects of the disclosure are equally applicable to apparatus and system aspects of the disclosure, and vice versa.

### BRIEF DESCRIPTION OF THE DRAWINGS

Features of the present disclosure will now be described with reference to the accompanying drawings, in which:

FIG. 1 illustrates schematically a plan view of a first embodiment of a conveyor system for conveying samples between functions;

FIG. 2 illustrates schematically a plan view of a second embodiment of a conveyor system for conveying samples between functions; and

FIG. 3 illustrates schematically a plan view of a third embodiment of a conveyor system for conveying samples between functions.

### DETAILED DESCRIPTION OF THE DISCLOSURE

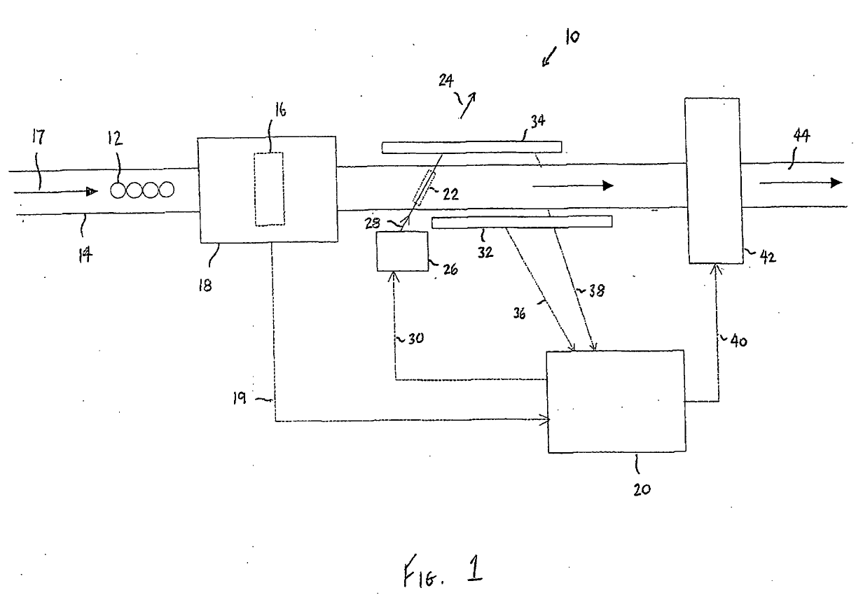

FIG. 1 illustrates schematically a first embodiment of a conveyor system 10. In one embodiment described herein, the conveyor system is used to convey sterile pharmaceutical glass or plastics vials 12 containing a pharmaceutical sample between functions, for example, between a freeze dryer and a capping station, or may be part of an in-line filling system for conveying containers between a filling station and a capping station. However, the conveyor system may be configured to convey containers other than vials, such as blister packs, ampoules and syringes.

A conveyer belt 14 conveys the vials at a controlled speed, typically a constant speed, through the system 10. The conveyor belt 14 generally comprises an endless chain driven by motor-driven gear wheels, and may be constructed from materials selected from a group including Kevlar®, Teflon®, polyester, polyurethane, aramide, glass, or other thermoplastic materials. As ampoules and syringes are highly mechanically unstable, the conveyer belt 14 may be adapted to hold such containers while being transported through the system 10. A row of vials 12 may be conveyed to the conveyor belt 14 using a star wheel system so that the vials 12 have a regular pitch, for example between 40 and 80 mm to inhibit cross-coupling effects between adjacent vials 12.

The conveyor belt 14 conveys the vials 12 through a mass interrogation zone 16 of an apparatus for determining the mass of the samples within the vials 12. As illustrated in FIG. 1, this mass interrogation zone 16 may extend substantially orthogonal to the direction of motion of the vials 12 on the conveyor belt 14, as indicated by arrow 17 in FIG. 1, and may be larger than the cross-section of the vials 12 perpendicular to the direction 17. Within the mass interrogation zone 16, a magnetic resonance apparatus 18 uses an NMR technique to provide, for each vial passing through the mass interrogation zone, a first signal 19 to a control system 20 for determining the mass of the sample within the vial. As is known, for example, from International Patent Application WO 2004/104989, the contents of which are incorporated herein by reference, the NMR apparatus 18 comprises a permanent magnet and an RF coil. The permanent magnet creates a homogenous direct current or static magnetic field in one direction across the conveyor belt 14. The RF coil applies a pulse in the form of an alternating current magnetic field to the sample at the sample's Larmor frequency and oriented orthogonal to the static magnetic field. This has the effect of exciting the sample by causing the sample's net magnetisation to rotate. After this pulse has been applied, the sample is in a high-energy, non-equilibrium state, from which the sample relaxes back to its equilibrium state. As the sample relaxes, electromagnetic energy at the Larmor frequency is emitted, the magnetic component of induces a current in the RF coil. The peak amplitude of the current varies with, among other things, the number of magnetic moments in the sample, and hence the number of molecules in the sample, and the temperature of the sample. The received signal is passed as the first signal 19 to the control system 20.

Where the sample is not fully magnetized by the static magnetic field when the pulse is applied, the peak amplitude of the current may be strongly dependant on the temperature of the sample. In order to provide temperature compensation of the first signal 19 so that the control system 20 can make an accurate determination of the mass of the sample, in this embodiment the vials 12 are subsequently conveyed to a temperature interrogation zone 22 at which the temperature of each sample is determined. As illustrated in FIG. 1, the temperature interrogation zone 22 is a region that extends obliquely relative to the direction of motion of the vials 12 on the conveyor belt 14, and may be larger than the cross-section of the vials 12 in the oblique direction 24 also indicated in FIG. 1. The temperature interrogation zone 22 may be located as close to the mass interrogation zone 16 as possible, and thus in this embodiment is located immediately downstream from the mass interrogation zone 16.

A light source 26 at least partially illuminates the temperature interrogation zone with a beam 28 with electromagnetic radiation. The light source 26 may be a laser configured to emit a beam having a near-infrared wavelength (“NIR radiation”) within the range from 700 to 2500 nm, or a laser configured to emit a beam having a terahertz frequency (“terahertz radiation”) within the range from 100 GHz (10¹¹ Hz) to 30 THz (3×10¹³ Hz). The light source 26 is preferable tuneable so that electromagnetic radiation of a desired wavelength or frequency can be emitted therefrom. As shown in FIG. 1, the control system 20 may generate control signals 30 for controlling the light source 26.

In the example illustrated in FIG. 1, two terahertz or NIR radiation detector arrangements 32, 34 are provided for detecting the radiation transmitted through and reflected from a vial 12 as it passes through the temperature interrogation zone 22, respectively. However, depending on the material of the sample and the nature of the radiation generated by the light source 26, only one of these two detector arrangements 32, 34 may be required. Each detector arrangement may comprise an array of individual detectors each for detecting terahertz or NIR radiation incident thereon. The imaging array may be provided by any suitable array of detectors, for example for terahertz radiation the detectors manufactured by Picometrix Inc., in which a microfabricated antenna structure is deposited over a fast photoconductive material, such as GaAs. The antenna structure serves to concentrate the incident radiation upon the surface of the GaAs layer, which creates a photocurrent within the detector. Second signals 36, 38 indicative of the amplitude and phase of the photocurrent generated within each detector arrangement 32, 34 respectively are output to the control system 20.

As the vial may be formed from glass or plastics material, the material from which the vial 12 is formed is substantially transparent to terahertz and NIR radiation. Consequently, the second signals 36, 38 output to the control system 20 from the detecting arrangements 32, 34 as the vial passes through the temperature interrogation zone 22 can provide information relating to the temperature of the sample contained within the vial 12 through distinctive absorption and/or reflection of terahertz or NIR radiation by the sample.

The control system 20 may analyse the received second signals spectroscopically to determine the temperature of the sample. For example, time domain waveforms can be obtained from the received signals, which may in turn be transformed using a Fourier transformation algorithm into frequency domain waveforms, which are dependent on the temperature of the sample. The control system 20 may be configured to compare the received waveforms with equivalent reference waveforms generated from a reference sample over a range of temperatures to determine the temperature of the sample as it passes through the temperature interrogation zone 22. As an alternative to performing a full analysis of the second signals 36, 38, the control system 20 may be configured to simply compare the signals 36, 38 received from the sample with a sequence of equivalent signals received from a cooling reference sample, and to determine the temperature of the sample from the equivalent signals which are closest to the received second signals 36, 38.

Using the thus-determined temperature of the sample within the temperature interrogation zone 22, the control system 20 performs temperature compensation of the first signal 19, for example, using an algorithm stored on the control system 20. This algorithm may be determined from a sequence of equivalent signals received from a cooling stationary reference sample of known mass. From the variation with temperature of the signals received from the reference sample, a temperature dependant correction factor for the first signal can be determined. By applying the appropriate correction factor to each first signal received from a respective sample conveyed through the mass interrogation zone 16, each first signal can be adjusted to produce a temperature-compensated first signal, which may be equivalent to the first signal that would have been obtained from the sample when conveyed through the mass interrogation zone at a known temperature. A characteristic of the temperature-compensated first signal can then be compared with a similar characteristic obtained from another, or the same, reference sample of known mass when at the known temperature to determine the mass of the sample.

Depending on the thus-determined mass of the sample, the control system 20 may determine that the vial 12 should be rejected from the stream of vials conveyed by the system 10, for example due to an unacceptably low mass of the sample within the vial. In this event, the control system 20 outputs a signal 40 to a reject station 42 provided downstream from the temperature interrogation zone 22 that a particular vial 12 is to be rejected. The reject station 42 can direct rejected vials to a reject buffer (not shown), and direct the non-rejected vials to an out-feed section 44 of the conveyor system 10.

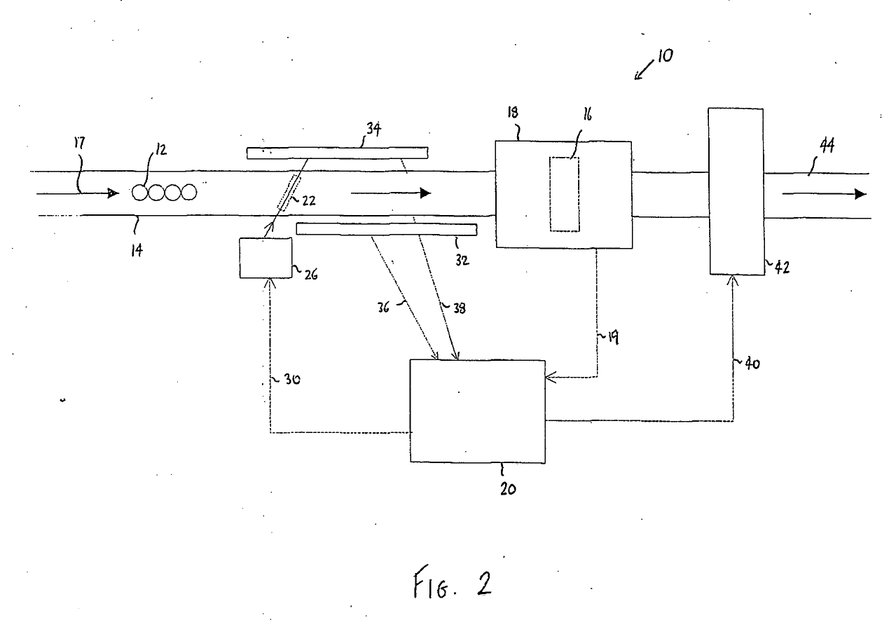

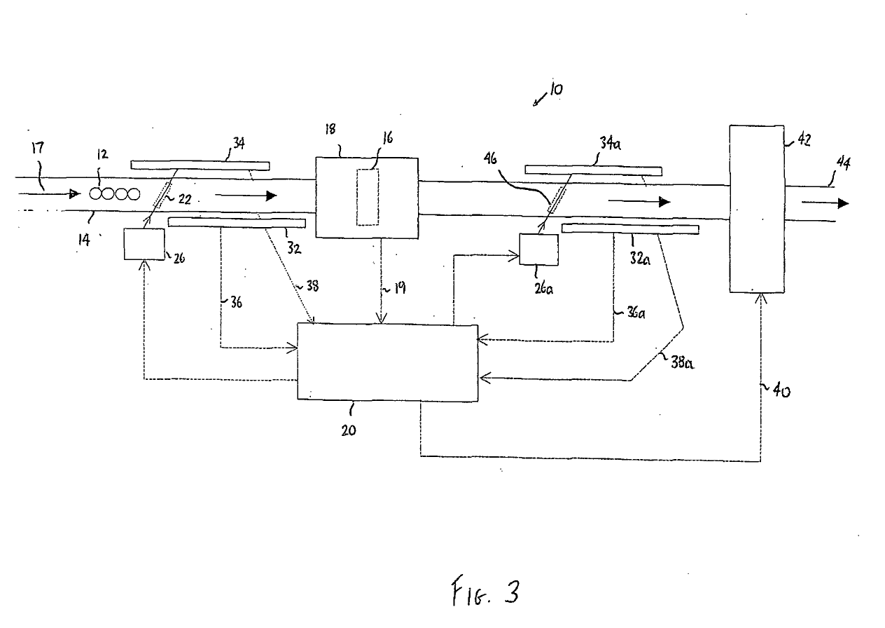

In the first embodiment illustrated in FIG. 1, the temperature interrogation zone 22 is located downstream from the mass interrogation zone 16. However, depending on the layout of the conveyor system 10, it may be impractical to locate the temperature interrogation zone 22 in this downstream position, and so, as illustrated in FIG. 2, the temperature interrogation zone 22 may be located upstream from the mass interrogation zone 16. In the embodiment illustrated in FIG. 3, the accuracy at which the temperature of the sample can be determined may be improved by providing both a first temperature interrogation zone 22 upstream from the mass interrogation zone 16 and a second temperature interrogation zone 46 downstream from the mass interrogation zone 16. The temperature interrogation zones 22, 46 are preferably substantially equidistantly spaced from the mass interrogation zone 16. As described above in relation to the first embodiment, a light source 26a is provided for directing a beam of terahertz or NIR radiation through the second temperature interrogation zone 46, and one or more detector arrangements 32a, 34a are provided for detecting the radiation reflected from and/or transmitted through the second temperature interrogation zone 46 as the vials 12 pass therethrough, and for outputting respective third signals 36b, 38b to the control system 20. By controlling the speed at which the vials 12 are conveyed between the temperature interrogation zones, 22, 46, the control system 20 is able to identify the second and third signals received from a particular vial 12. Using these signals, the control system 20 is able to determine an average temperature of the sample when conveyed between the temperature interrogation zones, 22, 46, and thus determine the temperature of the sample within the mass interrogation zone 12. For example, waveforms generated from the second and third signals may each be compared with the sequence of waveforms generated from the reference sample to determine the temperature of the sample as it passes through the first and second temperature interrogation zones respectively, with the average of these two temperatures providing an indication of the temperature of the sample within the mass interrogation zone 16. Where the first and second temperature interrogation zones 22, 46 are not equidistantly spaced from the mass interrogation zone 16, a weighted temperature correction of the first signal may be performed using the second and third signals.

In the event that the system is interrupted while vials are located between the temperature interrogation zones, 22, 46, as in the first and second embodiments, the control system 20 can use an appropriate one of the second and third signals to provide an indication of the temperature of the sample when the first signal was output to the control system 20.

In addition to providing information regarding the temperature of the sample, the second signal can be used to provide further information regarding the sample passing through the temperature interrogation zone. For instance, through distinctive absorption and/or reflection of terahertz and NIR radiation by different materials, physical and/or chemical characteristics of the sample can be determined. From the signals received from the detector arrangements when one or more broadband beams of terahertz radiation passes through the second (or third) interrogation zone, information regarding, for example, the presence and size of metallic particles and water concentrations, and homogeneity of suspensions can be obtained. When using a terahertz beam of a single frequency, information regarding the sample density can be obtained through measurement of the time of flight of the beam through the sample.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A method of determining the mass of a moving sample, the method comprising the steps of:
causing the sample to move at a controlled velocity through a mass interrogation zone and a temperature interrogation zone;
using a magnetic resonance method, generating a first signal as the sample passes through the mass interrogation zone, the first signal having a characteristic which varies with the mass of the sample and with the temperature of the sample;
generating a beam of electromagnetic radiation of a terahertz frequency or a near-infrared wavelength and directing the beam through the temperature interrogation zone;
detecting the electromagnetic radiation reflected from or transmitted through the sample as it moves through the temperature interrogation zone;
from the detected electromagnetic radiation, generating a second signal having a characteristic which varies with the temperature of the sample; and
using the first and second signals, determining the mass of the sample.

2. The method according to claim 1, wherein the characteristic of the first signal is adjusted using the second signal to produce a temperature compensated characteristic, the temperature compensated characteristic being compared to a similar characteristic obtained from a similar sample of known mass to determine the mass of the sample.

3. The method according to claim 2, wherein the second signal is compared with a similar signal obtained from a similar sample of known temperature to determine the temperature of the sample, the first signal being adjusted using the determined temperature to produce the temperature compensated characteristic.

4. The method according to claim 1, wherein the mass interrogation zone is located upstream from the temperature interrogation zone.

5. The method according to claim 1, wherein the mass interrogation zone is located downstream from the temperature interrogation zone.

6. The method according to claim 1, wherein the mass interrogation zone is located downstream from the temperature interrogation zone and upstream from a second temperature interrogation zone, the method further comprising the steps of:
causing the sample to move through the second temperature interrogation zone at a controlled velocity;
generating a further beam of electromagnetic radiation of a terahertz frequency or a near-infrared wavelength and directing the beam through the second temperature interrogation zone;
detecting the electromagnetic radiation reflected from or transmitted through the sample as it moves through the second temperature interrogation zone; and
from the detected electromagnetic radiation, generating a third signal having a characteristic which varies with the temperature of the sample;
wherein the mass of the sample is determined using the first, second and third signals.

7. The method according to claim 6, wherein the characteristic of the first signal is adjusted using the second and third signals to produce a temperature compensated characteristic, the temperature compensated characteristic being compared to a similar characteristic obtained from a similar sample of known mass to determine the mass of the sample.

8. The method according to claim 7, wherein the second and third signals are each compared with a similar signal obtained from a similar sample of known temperature to determine the temperature of the sample as it passes through the temperature interrogation zones, the first signal being adjusted using the determined temperatures to produce the temperature compensated characteristic.

9. The method according to claim 8, wherein the temperature interrogation zones are substantially equidistantly spaced from the mass interrogation zone, and the characteristic of the first signal is adjusted using the average of the determined temperatures.

10. The method according to claim 6, wherein the second temperature interrogation zone extends obliquely to the direction of movement of the sample therethrough.

11. The method according to claim 1, wherein the temperature interrogation zone extends obliquely to the direction of movement of the sample therethrough.

12. The method according to claim 1, wherein the or each signal having a characteristic which varies with the temperature of the sample is generated by generating at least one time domain waveform from the detected radiation.

13. The method according to claim 12, wherein the or each signal having a characteristic which varies with the temperature of the sample is generated by generating at least one frequency domain waveform from said at least one time domain waveform.

14. The method according to claim 1, wherein the sample is located within a container that is substantially transparent to the beam of electromagnetic radiation.

15. The method according to claim 14, wherein the container is formed from glass or plastics material.

16. The method according to claim 1, wherein the detection of electromagnetic radiation is performed by an array of detectors.

17. The method according to claim 1, wherein the electromagnetic radiation is of a terahertz frequency and has a frequency within the range from 100 GHz (10¹¹ Hz) to 30 THz (3×10¹³ Hz).

18. The method according to claim 1, wherein the electromagnetic radiation has a near-infrared wavelength and has a wavelength in the range from 700 to 2500 nm.

19. The method according to claim 1, wherein the first signal is generated by applying a first magnetic field in a first direction in the mass interrogation zone for creating a net magnetisation within the sample, applying an alternating magnetic field in a second direction in the mass interrogation zone for temporarily changing the net magnetisation of the sample, and monitoring energy emitted from the sample as the net magnetisation of the sample returns to its original state, whereby the characteristic of the first signal is proportional to the energy emitted.

20. The method according to claim 1, wherein the samples comprise pharmaceutical samples contained within a container.

21. The method according to claim 20, wherein the container is a vial or ampoule.

22. The method according to claim 1, wherein at least one other physical or chemical characteristic of the sample is determined using the second signal.

23. The method according to claim 22, wherein the chemical composition of the sample is determined using the second signal.

24. The method according to claim 22, wherein the density of the sample is determined using the second signal.

25. The method according to claim 22, wherein the homogeneity of the sample is determined using the second signal.

26. Apparatus for determining the mass of a moving sample, the apparatus comprising:
conveying means for conveying the sample at a controlled velocity through a mass interrogation zone and a temperature interrogation zone;
magnetic resonance apparatus for generating a first signal as the sample passes through the mass interrogation zone, the first signal having a characteristic which varies with the mass of the sample and with the temperature of the sample;
first generating means for generating a beam of electromagnetic radiation of a terahertz frequency or a near-infrared wavelength and directing the beam through the temperature interrogation zone;
detecting means for detecting the electromagnetic radiation reflected from or transmitted through the sample as it moves through the temperature interrogation zone;
second generating means for generating from the detected electromagnetic radiation a second signal having a characteristic which varies with the temperature of the sample; and
determining means for using the first and second signals to determine the mass of the sample.

27. A conveyor system comprising conveying means for conveying a sample at a controlled velocity through a mass interrogation zone and a temperature interrogation zone, magnetic resonance apparatus for generating a first signal as the sample passes through the mass interrogation zone, the first signal having a characteristic which varies with the mass of the sample and with the temperature of the sample, first generating means for generating a beam of electromagnetic radiation of a terahertz frequency or a near-infrared wavelength and directing the beam through the temperature interrogation zone, detecting means for detecting the electromagnetic radiation reflected from or transmitted through the sample as it moves through the temperature interrogation zone, second generating means for generating from the detected electromagnetic radiation a second signal having a characteristic which varies with the temperature of the sample, determining means for using the first and second signals to determine the mass of the sample, and rejecting means for rejecting the sample in dependence on the determined mass of the sample.
